(19) United States
(12) Patent Application Publication
(10) Pub. No.: US 2019/0168187 A1
(43) Pub. Date: Jun. 6, 2019

(54) DESICCANT COMPOSITION AND USE

(71) Applicant: Glass Polymer Technologies, LLC, Prairie du Sac, WI (US)

(72) Inventors: Kurt Heikkila, Marine on the St. Croix, MN (US); Annette Krisko, Prairie du Sac, WI (US)

(21) Appl. No.: 16/323,048

(22) PCT Filed: Aug. 4, 2017
(86) PCT No.: PCT/US17/45564

§ 371 Date: Feb. 4, 2019

Related U.S. Application Data
(60) Provisional application No. 62/371,116, filed on Aug. 4, 2016.

(51) Int. Cl. B01J 20/28; B01J 20/32; B01J 20/10; B01J 20/18; E06B 3/677

(52) U.S. Cl. CPC B01J 20/28028; B01J 20/28033; B01J 20/3293; B01J 20/103; B01J 2220/50; B01J 20/3268; E06B 3/677; B01J 20/28004; B01J 20/18

(57) ABSTRACT

The compositions and methods that can be used in desiccants in manufactured units requiring an enclosed atmosphere with minimal water and volatile content. Such materials need to maintain a low concentration of volatile materials in an enclosed space in a unit to avoid any unneeded interference of water or other volatiles in the utility of the unit. In one application, the desiccant material can keep the insulated glass units (IGUs) from fogging, which includes forming water or depositing volatiles on internal surfaces.

### CROSS-REFERENCE TO RELATED APPLICATION

This application claims the benefit of U.S. Provisional Patent Application Ser. No. 62/371,116, filed Aug. 4, 2016 which application is hereby incorporated by reference in its entirety.

### FIELD

The claimed materials generally relate to compositions and methods that can be used as desiccants in manufactured units requiring an enclosed atmosphere with minimal water content. Such materials need to maintain a low concentration of water in an enclosed space in a unit to avoid any unneeded interference of water or other volatiles in the utility or transparency of the unit. In one application, the desiccant material can keep the insulated glass units (IGUs) from fogging, which includes forming liquid water or depositing filming from volatiles on internal surfaces.

### BACKGROUND

Desiccant materials have been used to reduce water concentration in closed spaces. Silica gel packets are common in retail and other packaging. Many desiccants are used in desiccators in laboratory applications. In many industrial processes, desiccator layers are used to dry process flows. These materials are used in a loose powdered or granular form and can only be used in applications where a bed can be maintained intact. In one embodiment, an insulated glass unit (IGU) is made by separating glass sheets with a typically hollow metal spacer. Within the IGU, the spacer defines an enclosed interior defined by the glass sheets and the spacer. Within the spacer typically is an enclosed volume. The enclosed volume can contain a desiccant. The desiccants have the capacity of adsorbing moisture or volatile materials (VOC's) that arises from the gasses introduced into the internal window space during manufacture or derived from window components. Moisture can permeate through the window seals after installation. Desiccants can also adsorb typically volatile organic contaminants (VOC's) that can arise from components used in IGU manufacture. Adsorbing organics and moisture prevent chemical or moisture fogging. Currently, desiccants are used in the form of a pellet powder or granular bed, or as a desiccant dispersed as a discrete particulate in a continuous polymer phase/composition in a continuous extruded mass or bead. Powdered, granular or pellet desiccants must be carefully handled and applied to avoid entry of desiccant dust into the window space. Extruded polymer containing desiccants are hot applied as a thermoplastic layer. Desiccants can also be cold applied in the form of a curable polymeric system. Extruded materials have limited adsorbing rates and capacity since the desiccant is fully contained in a polymer continuous phase.

A substantial need exists for an improved desiccant that adsorbs moisture and organic contaminants, maintains an improved adsorption rate and capacity, has minimal off-gassing, does not adsorb argon, nitrogen or oxygen from the internal IGU space and is easily handled, combined and maintained within the glass and spacer in IGU manufacture.

### SUMMARY

The claimed material relates to an article comprising a desiccant particulate and a fiber web. The desiccant particulate can comprise a coated particle or a particle of a desiccant dispersed in a polymer phase. The web comprises a polymer coated desiccant particulate and a bicomponent fiber. The bicomponent fiber sheath is fused, adhered or bonded to the polymer coated desiccant particle. In one embodiment, the desiccant is held within a web of bicomponent fibers. In another, the desiccant comprises a discrete layer bonded to a discrete web layer. In one other embodiment, the web, having a width substantially smaller that its length, comprises a desiccant particulate formed in a web of thermally fused bicomponent fibers. In one further embodiment, the claimed materials relate to a web adapted to fit within an IGU spacer. In still another embodiment, the claimed material relates to a laminate of at least one fused bicomponent layer and at least one layer of desiccant particulate in a web of thermally fused bicomponent fibers. In additional embodiments, the claimed material relates to an IGU spacer containing an article of a desiccant particulate formed in a web of thermally fused bicomponent fibers. In a still further embodiment, the claimed material relates to an IGU with an IGU spacer containing an article of a desiccant particulate formed in a web of thermally fused bicomponent fibers. Also contemplated are methods of making the desiccant layer or layers and the IGU spacer and related IGU window units.

The above summary is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The term “web” means single or multi-layer sheet-like article containing fiber. The article can contain a woven or non-woven array of fiber or threads that interact to form the article layer structure.

The term “fiber” means a thread or filament that can be used to make a woven or non-woven layer.

The term “Bicomponent fiber” means a fiber formed from a thermoplastic material having at least one structural fiber portion with a melting point and a second thermoplastic fiber-fusing or fiber crosslinking portion with a lower melting point. Bicomponent fiber is typically comprised of two polymers of different chemical or physical properties. The polymers are extruded from the same spinneret with discrete portions of both polymers formed within the same filament. Webs can be formed from a layer of bicomponent fiber by heating the fiber to a temperature above the lower melting temperature but below the melting temperature of the other. The physical configuration of these fiber portions is typically in a side-by-side or sheath-core structure. In side-by-side structure, the two resins are typically extruded in a connected form in a side-by-side structure. In a sheath-core structure, the material with the lower melting point forms the sheath. It is also possible to also use lobed fibers where the tips have lower melting point polymer. The lower melting temperature acts to bond or fuse the fibers while the higher temperature acts as a mechanical reinforcement.

The term “secondary fiber” typically is not a bicomponent fiber and is made of a single material.

“Fiber diameter” means the measured width of the fiber, typically in denier or microns. This is easily measured using microscopic methods.

The term “Denier” is a measure of fiber size and is equal to the weight in grams of 9,000 meters of the fiber. Denier can be converted to fiber diameter using known methods.

The term “fluff” means a typically loose, soft, light collection of fiber with a bulk density much lower than composition of the fiber alone.

The term “air laid” means a layer that is not formed using a liquid (aqueous or solvent) media but is formed by a heated or ambient air stream. The air driven collection of one or more fiber types can be collected and formed into a mechanically stable web layer or article through the application of heat.

The term “particulate” means a collection of discrete particles in a distribution of particle sizes. A “particle” means one of the collection that is a particulate. A particle typically refers to an object, as a composite particle containing on or more particle species of a mono-component or single species, less than 5 mm that has an aspect ratio of less than 3:1. Many useful mono-component particulates have a size between 500 microns and 0.1 micron. Particulates are commonly sold as a collection of particles in a defined range.

The term “desiccant” means a typically finely divided or powdered material that can be used as a drying agent due to its affinity to or reaction with atmosphere moisture. Desiccants can also have a capacity to absorb or adsorb volatile organics.

The term “partial coating” means that a coating on a desiccant particle reveals sufficient uncoated surface area such that the moisture absorbent character of the desiccant is not substantially reduced in the desiccant article.

The term “bonded” in this disclosure means that, in a structure, a mechanical attachment is formed between two substrates that can maintain the structure in a stable form for the design purposes of the structure.

The term “fused” in this disclosure means that at least a portion of the surface of a first object is heated to or above a melting point forming a melted portion and is contacted with a second object such that contact forms a bond between the first and second object through contact and cooling of the melted portion. “Fusing” may also be accomplished using ultraviolet (UV), ultrasonic energy, microwave and other methods known in the bonding or adhering arts.

The term “dispersion” means a continuous phase with a discontinuous phase formed therein. The term “dispersed” means that a discontinuous phase (e.g.) a particle is contained in a continuous phase of a polymer or fiber. A dispersion is formed by combining a polymer or fiber with an amount of a particle, wherein the particle forms discontinuous phase in the continuous phase.

The term “insulated glass unit” or “IGU” is used as that term is understood in the art. Generally, two or more sheets of glass are positioned parallel and separated by a conventional spacer forming a volume defined by the glass and spacer that is filled with dry air, nitrogen, argon or other gas. Such spacers can contain a powdered, granular or extruded desiccant material within the spacer structure.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

The terms “comprise or comprises” and variations thereof do not have a limiting meaning where these terms appear in the description and claims.

As used in this specification and the appended claims, the term “or” is generally employed in its inclusive sense including “and/or” unless the content clearly dictates otherwise.

### BRIEF DESCRIPTION OF THE DRAWINGS

The disclosure may be more completely understood in consideration of the following detailed description of various embodiments of the disclosure shown in the accompanying drawings, in which:

FIG. 1 is an isometric view of one embodiment of the desiccant layer that can be used in an insulated glass unit (IGU);

FIG. 2 is an isometric view of one embodiment of the desiccant web in a bilayer structure that can be used in an insulated glass unit (IGU);

FIG. 3 is an isometric and cross sectional view of an insulated glass unit containing the desiccant layer as claimed.

The figures are not necessarily to scale. Like numbers used in the figures often refer to like components. However, the use of a number to refer to a component in a given figure is not intended to impose any limit on the structure or place a limit on the component in another figure labeled with the same number.

### DETAILED DESCRIPTION

This disclosure relates to a desiccant article comprising a desiccant particulate formed in a web of thermally fused bicomponent fibers.

The claimed materials and articles use a fused bicomponent fiber as a portion of the materials or article. The polymers of bicomponent (e.g., sheath/core or side-by-side) fibers can be made up of different thermoplastic materials. Useful thermoplastic polymers include polyvinyl acetate, polyvinyl chloride acetate, polyvinyl butyral, acrylic resins, e.g. polyacrylate, and polymethylacrylate, polymethylmethacrylate, polyamides, namely nylon, polyvinyl chloride, polyvinylidene chloride, polystyrene, polyvinyl alcohol, polyurethanes, cellulosic resins, namely cellulosic nitrate, cellulosic acetate, cellulosic acetate butyrate, ethyl cellulose, etc., copolymers of any of the above materials, e.g. ethylene-vinyl acetate copolymers, ethylene-acrylic acid copolymers, styrene-butadiene block copolymers, Kraton® rubbers and the like.

The first fiber or the scaffold fiber can comprise a bicomponent fiber comprising a core and a shell each independently comprising a polyester or a polyolefin. Any of these can be used that demonstrate the characteristic of fusing bonding or cross-linking the sheath to fiber or particle upon completion of melt fusion. One useful fiber is a polyolefin/polyester, bicomponent fiber. The polyolefin, e.g. polyethylene sheath, melts at a temperature lower than the core, e.g. polyester core. Typical thermoplastic polymers include polyolefin, e.g. polyethylene, polypropylene, polybutylene, and copolymers thereof, and polyesters such as polyethylene terephthalate. An example is a polyester bicomponent fiber known as 271P available from DuPont. Others fibers include FIT 201 available from Fiber Innovation Technology of Johnson City, Tenn., Kuraray N720 available from Kuraray Co., Ltd. of Japan, and Unitika 4080 available from Unitika of Japan, and similar materials.

A secondary fiber, typically not a bicomponent fiber, can be used in the articles as an aid to making a stable, permeable web or article. The fibers can be of a variety of compositions, diameters and aspect ratios. Diameter is the width of the fiber typically measured with microscope inspection. Aspect ratio is the ratio obtained by dividing the fiber length by its diameter. Such fibers are normally processed from either organic or inorganic sources. The requirements of the specific application may make a choice of fibers, or combination of fibers, more suitable. The fibers of the gradient media may comprise bicomponent, glass, cellulose, a polyolefin, polyester, a polyamide, a halogenated polymer, polyurethane, acrylic or a combination thereof.

Cellulose, cellulosic fiber or mixed cellulose/synthetic fiber can be a basic component of the composite medium. The cellulosic fiber can be a separate layer or can be combined in a single layer. Although available from other sources, cellulosic fibers are derived primarily from wood pulp. Suitable wood pulp fibers for use in the invention can be obtained from well-known chemical processes such as the Kraft and sulfite processes, with or without subsequent bleaching. The preferred pulp fiber is produced by chemical methods. Ground wood fibers, recycled or secondary wood pulp fibers, and bleached and unbleached wood pulp fibers can be used. Softwoods and hardwoods can be used. Details of the selection of wood pulp fibers are well known to those skilled in the art. These fibers are commercially available from several companies. Fibers made from cellulose are a non-limiting example of degradable fibers that may be used in certain embodiments. The wood pulp fibers can also be pretreated prior to use in the present invention. This pretreatment may include physical or chemical treatment, such as combining with other fiber types, subjecting the fibers to steam, or chemical treatment, for example, crosslinking the cellulose fibers using any one of a variety of crosslinking agents. Crosslinking increases fiber bulk and resiliency.

Synthetic fibers including polymeric fibers, such as polyolefin, polyamide, polyester, polyvinyl chloride, polyvinyl alcohol (of various degrees of hydrolysis), polyvinyl acetate fibers, and can also be used in the composite. Suitable synthetic fibers, secondary fibers, include, for example, polyethylene terephthalate, polyethylene, polypropylene, nylon, and rayon fibers. Other suitable synthetic fibers include those made from thermoplastic polymers, cellulosic and other fibers coated with thermoplastic polymers, and multi-component fibers in which at least one of the components includes a thermoplastic polymer. Single and multi-component fibers can be manufactured from polyester, polyethylene, polypropylene, and other conventional thermoplastic fibrous materials.

Such secondary fibers made from several both hydrophilic, hydrophobic, oleophilic, and oleophobic fibers. These fibers cooperate with other fibers to form a mechanically stable, but strong, permeable composite or article that can withstand the mechanical stress of the passage of atmosphere or humidity and can maintain the loading of particulate during use. Secondary fibers are typically mono-component fibers with a diameter that can range from about 0.1 to about 50 microns and can be made from a variety of materials including naturally occurring cotton, linen, wool, various cellulosic and proteinaceous natural fibers, synthetic fibers including rayon, acrylic, aramid, nylon, polyolefin, polyester fibers.

One type of secondary fiber is a mono-component binder fiber that cooperates with other components to bind the materials into a sheet. Another type of secondary fiber is a structural fiber that cooperates with other components to increase the tensile and burst strength the materials in dry and wet conditions. Additionally, the binder fiber can include fibers made from such polymers as PTFE, polyvinyl chloride, polyvinyl alcohol. Secondary fibers can also include inorganic fibers such as carbon/graphite fiber, metal fiber, ceramic fiber and combinations thereof. Conductive fibers (e.g.) carbon fibers or metal fibers including aluminum, stainless steel, copper, etc. can provide an electrical gradient in the media. Due to environmental and manufacturing challenges, a fiber that is chemically and mechanically stable during manufacture and use is preferred. Any of such fibers can comprise a blend of fibers of different diameters.

The materials and articles claimed can contain a desiccant composite particle, multiple species particle, or single species particle. The desiccant does its job of protecting the product as a porous absorbent or adsorbent or by chemically reacting with humidity or VOC materials. Moisture trapped within a product, such as for example and insulated glass unit (IGU) or other examples of fenestration, or leaking into it during storage and shipping can cause many problems. In window units, fogging and corrosion are examples of many problems that may result. The stability of the product, as well as the maintenance of the physical product integrity, is often closely tied to the moisture and VOC conditions of the product sealed environment. In some conditions, moisture can promote the growth of mold, mildew and fungus. Products using some polymers are prone to swelling in high humidity conditions as intermolecular bonding between polymer chains can be weakened by the presence of water. In some cases, water can become an integral part of the bulk crystal structure of a product through the formation of hydrates.

Humidity and VOC adsorption involves relatively weak intermolecular forces (van der Waals forces and electrostatic interactions) between the moisture and surface of the desiccant. Chemisorbents, such as calcium oxide, involve an actual chemical bond. Physical adsorption of moisture is typically exothermic. The strength of the adsorptive bonds can thus be measured by the heat of adsorption. The higher the heat of adsorption for moisture on the desiccant, the stronger the bonding and the less easily that moisture can be subsequently removed. So often when the word “desiccant” is used, people automatically think of the three main types of absorbent desiccants such as for example Silica Gel, Molecular Sieve (zeolites), and Clay desiccant. Other useful reactive desiccants are Calcium Oxide, Montmorillonite Clay and Calcium Sulfide. Useful desiccants are absorbers such as silica gel, activated clay or molecular sieves that rely upon physical adsorption rather than chemical adsorption to accomplish their function.

Montmorillonite clay is a naturally occurring adsorbent created by the controlled drying of magnesium aluminum silicate of the sub-bentonite type. This clay will successfully regenerate for repeated use at very low temperatures without substantial deterioration or swelling. However, this property causes clay to give up moisture readily back into the container as temperatures rise. Clay is a good basic desiccant that works satisfactorily below 120° F. (approximately 50° C.). Above 120° F., there is a possibility that the clay will give up moisture rather than pulling it in, so anticipated storage and transportation conditions should be considered. The upside to clay is that it is normally the least expensive desiccant per pound. Clay is highly effective within normal temperature and relative humidity ranges. Its appearance is that of small gray pellets. Care should be taken to be sure that any low-level impurities in the clay are not incompatible with the product.

Silica gel is silicon dioxide (SiO₂). It is a naturally occurring mineral that is purified and processed into either granular or beaded form. As a desiccant, it has an average pore size of 24 angstroms and has a strong affinity for moisture molecules. The silica gel will pull in moisture at temperatures up to 220° F. (105° C.). As temperature goes above 100° F., the rate of moisture pickup will slow down but the silica gel will still work. Silica gel performs best at room temperatures (70° to 90° F.) and high humidity (60 to 90% RH) and will drop the relative humidity in a container down to around 40% RH. In the United States, silica gel is commonly used in food and pharmaceutical applications as only silica gel has been approved by the FDA for direct contact with these items. As with clay, silica gel, with its wide range of pore sizes, has the capability of adsorbing compounds other than water. The relative order of absorbability is: water, ammonia, alcohols, aromatics, diolefins, olefins and paraffins. When the potential for multicomponent adsorption is present, expect the more strongly adsorbed compounds, such as water, to displace the more weakly held ones.

Molecular sieve (synthetic zeolites) is an effective desiccant based on technical performance characteristics. Its ability to adsorb moisture, in this case water vapor, is so pronounced that it can remove trapped H₂O molecules from a fully saturated silica gel bead. Molecular sieves are synthetic porous crystalline aluminosilicate which have been engineered to have a very strong affinity for specifically sized molecules. The definitive feature of the molecular sieve structure, as compared to other desiccant media, is the uniformity of the pore size openings. There is no pore size distribution with molecular sieves, as part of the manufacturing process the pore size on the molecular sieve particles can be controlled. The most commonly used pore size is 4 angstroms (4 A) although 3 angstroms (3 A), 5 angstroms (5 A) and 10 angstroms (13X) are available. This distinctive feature allows for the selection of a molecular sieve product which can adsorb water vapor yet exclude most other molecules such as volatile organic compounds (VOCs) which may or may not be present in the package.

For example: 3 A molecular sieve's structure, having a 3 angstrom pore opening, allows water vapor adsorption but excludes most hydrocarbons. 3 A is good for ammonia (NH₃), water vapor (H₂O) and polar liquids. 4 A molecular sieve has a slightly higher water vapor capacity but adsorbs molecules as large as butane. 4 A is good for water vapor (H₂O); carbon dioxide (CO₂); sulfur dioxide (SO₂); hydrogen sulfide (H₂S); ethylene (C₂H₄); ethane (C₂H₆); propene (C₃H₆) and ethanol (C₂H₆O). 5 A molecular sieve adsorbs normal (linear) hydrocarbons to n-C₄H₁₀, alcohols to C₄H₉OH, and mercaptans to C₄H₉SH. The 5 angstrom molecular sieve will not adsorb iso-compounds or rings greater than C₄. 10 A molecular sieve (13X) adsorbs di-n-butylamine (not tri-n-butylamine) and is useful for drying HPMA. The selective adsorption characteristics of molecular sieves can be useful when it is necessary to dry an environment without removing other desirable compounds within the system. Molecular sieve can trap water vapor to temperatures well past 225° C. in some cases, and due to its high affinity for water vapor, molecular sieve is able to bring the relative humidity (RH) in environments down to as low as 1% RH. Although molecular sieve is slightly higher in cost per unit due to its extremely large range of adsorptive capabilities and high capacity at low relative humidity, it is often the best value.

Calcium compound can be used. Calcium oxide is calcined or recalcined lime having a moisture adsorptive capacity of not less than 28.5% by weight. The distinguishing feature of calcium oxide (also known as quicklime) is that it will adsorb a much greater amount of water vapor at a very low relative humidity than other materials. It is most effective where a low critical relative humidity is necessary, and where there is a high concentration of water vapor present. Calcium oxide removes water from a package very slowly, often taking days to reach its maximum capacity. As calcium oxide adsorbs moisture, it swells. Proper desiccant handling is required for effective use. Calcium sulfate (better known commercially as Drierite® T) is created by the controlled dehydration of gypsum. A general purpose desiccant is geared mainly toward laboratory use. It is chemically stable, non-disintegrating, nontoxic, non-corrosive and does not release its adsorbed water easily when exposed to higher ambient temperatures. The low cost of calcium sulfate must be weighed against its equally low adsorptive capacity; it adsorbs only up to 10% of its weight in water vapor. Calcium sulfate also has regeneration characteristics that tend to limit its useful life.

Other adsorbents are available for specialized functions if needed. For example, activated alumina is a porous desiccant which performs very similarly to silica gel, providing somewhat lower moisture capacity at low temperatures, but slightly improved capacity at higher temperatures. Some of these alternative desiccant products have a specialized function. Others, ranging from metal salts to phosphorus compounds, have specific strengths that would be impossible to address individually. Often it is left up to the desiccant supplier to answer specific questions.

The desiccant can be in the form of a collection of discrete particles and can be an agglomerate of particles if the particle size is less than 2 mm. The desiccant can be mechanically held or immobilized in the article by fusing the particle to the bicomponent fibers. Alternately, the desiccant can be bonded to the bicomponent fibers or secondary fibers by bonding through a thermoplastic polymer component. While the thermoplastic polymer can aid in forming the article, excess polymer can inhibit desiccant activity. An amount of polymer that results in no more than 50% wt. % of the coated particle can be used. In some embodiments, the polymer component cannot fully coat the particle. No more than 70% of the particle surface, 50% of the particle surface or 40% of the particle surface can be occupied by the polymer or less. The selection of polymer type and coating extent can control and adjust moisture and VOC absorption of the particle through the polymer coating.

Desiccant applications are many and are not limited by the following list: Electronics, Food, Shipping, Sailing; Tools, Travel, Pharmaceuticals, Chemicals, Construction and Relocation; and etc. A short list of other areas where desiccants can be an indispensable benefit include the following non-limiting list: Laboratory equipment and hygroscopic chemicals, shoes and other leather articles, Books and rare manuscripts, Photo slides and film, Hearing aids, Guns, gun accessories, and fishing tackle, Stamps, Surgical and dental instruments, Pharmaceuticals, Clothing and fabrics, Scientific instruments, Museum and historical artifacts, Paintings and valuable art objects, Athletic equipment and many other areas.

The commonly used desiccants in the Insulated Glass (IG) industry are molecular sieves or a blend of silica gel with molecular sieves. Highly porous crystals of molecular sieves with uniform pore sizes of 3, 4, 5, and 10 Angstroms (Å) exist, each having a strong affinity for a specific size of molecule. The 3-Å molecular sieve's structure allows water vapor adsorption yet excludes most other molecules. The 4-Å molecular sieve has a slightly higher water vapor capacity but also adsorbs larger molecules including oxygen and nitrogen; it is, therefore, less commonly used in IG edge seals. Molecular sieves have a high adsorption capacity at low relative humidity and are therefore particularly useful in dry environments such as the interpane glazing space between glass sheets and spacer. Silica gel is a highly porous granular-shaped desiccant with pore sizes ranging from 20 to 200 Å. Because of this wide range of pore sizes, silica gel is capable of adsorbing compounds other than water, such as ammonia, alcohols, aromatics, diolefins, olefins, and paraffins. A blend of 3-Å molecular sieve and silica gel can prevent both condensation and chemical fogging by adsorbing water vapor as well as off-gassed organics while also limiting the adsorption of argon or nitrogen gas. In a porous desiccant, such as silica gel or zeolite, water is removed from the airspace by: 1) multi-layer adsorption, which is the attraction of thin layers of water or chemical molecules to the surface of the desiccant. Because the desiccant is very porous, the surface area is high and significant amounts of water can be attracted and adsorbed; 2) by capillary condensation in which the smaller pores become filled with water or chemical molecules. Capillary condensation occurs because the saturation vapor pressure in a small pore is reduced by the effect of surface tension.

The term airlaid refers to a manufacturing technology that produces a web from an air driven fiber source. One principal fiber used to produce the claimed airlaid materials is a bicomponent fiber, it can be used with other fibers as discussed above. A secondary fiber fluff pulp, other natural and synthetic fibers can be used. The airlaid process was originally conceived as a method of making paper without the use of water. In paper making, wood pulp is bonded principally by a chemical reaction between the pulp's natural cellulose and water. To enhance the paper's strength bonding agents such as resin are added. In contrast, airlaid nonwoven technology generally uses bicomponent fiber bonding. The bicomponent bonding can be augmented with latex emulsions, thermoplastic mono-component fibers or some combination of both to bond the web fibers and increase the strength and integrity of the sheet.

In the structures claimed the bicomponent fiber forms a continuous fiber layer. The desiccant can be a dispersed material in the fiber layer or can be a layer formed between two or more layers.

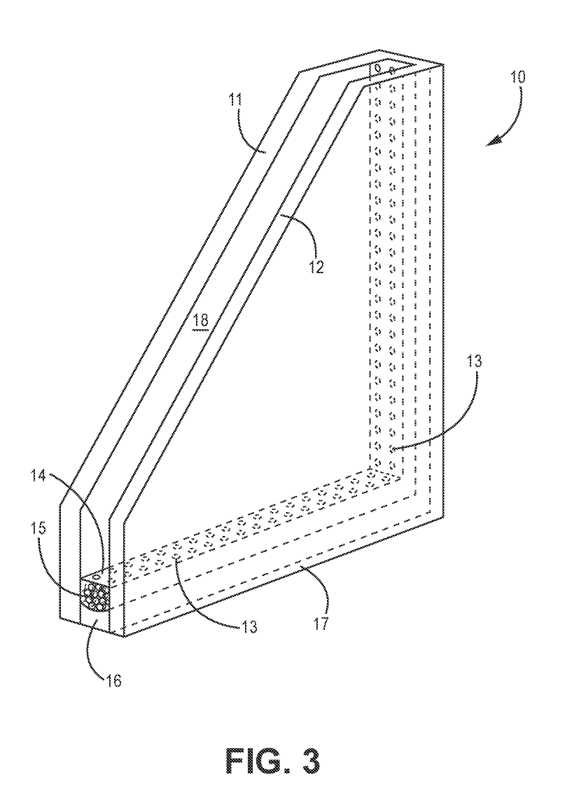

An insulating glass unit (IGU) 10 as shown in FIG. 3, commonly consists of at least two (sometimes more) panes of glass 11 and 12 separated by a spacer material formed of a metal enclosure 14, a desiccant 15 and a sealant structure 16. The desiccant 15 is exposed to the interior of space 18 of the unit by the presence of pores or other apertures 13 in the enclosure 14. At the coextensive perimeter, the glass panes, spacer and sealant are joined together at the common edge(s) 17. The IGU can be sealed by one or more sealant(s) 16. A primary sealant can fully seal the IGU edge covering the spacer entirely. The spacer can be held in place by secondary sealants or adhesives. The insulating space 18 is filled with air or a noble gas, such as argon or krypton inside. Each glass pane has two surfaces, so typical double-paned IGUs have four parallel surfaces. In the use of the articles claimed, the IGU spacer typically encloses a volume that can be partially or completely occupied by desiccant.

The articles can be made from bicomponent fibers or from fibers combined with or blended with the bicomponent fibers. Blending of the fibers begins with metering the fibers and bicomponent fibers at the desired weight ratio into a mixer. As will be generally understood by one of ordinary skill in the art, metering may be variable by as much as ±1-2% by weight of each component due to machine capability. Various methods for metering the fibers are known including using a screw auger, pocket chamber or by drop feeding. The bicomponent or blended fibers and bicomponent fibers are then integrally mixed in a mixing step, which is important because good dispersion of the bicomponent fibers in the fibers is necessary to affect the bonding which will be discussed in more detail below. Methods of mixing include blending in an airstream or other mechanical mixing device (e.g. an attrition mill) and the like.

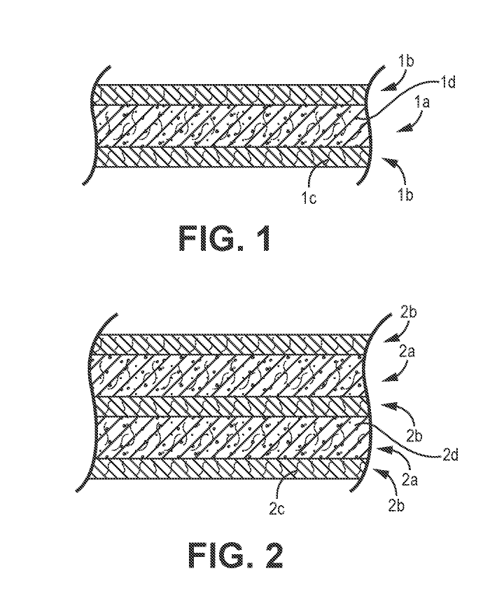

The desiccant particles can be added and blended with the fibers (1) at this preliminary fiber blending stage to make the fiber and particle dispersion, (2) can be added to the fibers during air laying process to make the dispersion, or (3) or can be added to the fibers after air laid layer formation FIG. 1 to make the dispersion. FIG. 1 shows the construction of a desiccant web with a dispersion of the desiccant particles attached to the fibers. In FIG. 1, 1a shows a discrete layer of the particles attached to the fibers, for example bicomponent fibers, at 1d. Non-dispersion containing fibers 1b provide properties such as strength and porosity that provides permeability and access of the moisture and VOCs to the desiccant in the dispersion. Optionally, other fibers 1c may be in the web to provide other properties such as density, additional strength or porosity.

In FIGS. 1 and 2, a laminate structure is shown. FIG. 1 shows a single layer containing desiccant. FIG. 2 shows two or more layers of fiber enclosing two or more desiccant layers. FIG. 2 shows the construction of a desiccant web with a dispersion of the desiccant particles attached to the fibers in multiple and discrete layers. In FIG. 2, 2a shows a discrete layer of the particles attached to the fibers, for example bicomponent fibers, at 2d. Non-dispersion containing fibers 2b provide properties such as strength and porosity that controls the access of the moisture and VOCs to the desiccant in the dispersion. Optionally, other fibers 2c may be in the web to provide other properties such as additional strength or porosity. FIG. 2 shows an embodiment showing two discrete layers of the desiccant web dispersion. Multiple layers, greater than 2, of desiccant web dispersions are contemplated as well as multiple layer of non-desiccant containing fiber layers

In any of FIG. 1 to FIG. 3, the desiccant combined with bicomponent fibers or the integrally mixed fibers and bicomponent fibers in an airlaid composite can be processes to form a uniform structure of one two or more layers. A vacuum means may also be included for drawing the fibers against the screen to form the uniform structure. Compaction of a layer can utilize a set of rollers above and below the airlaid material for compaction, giving an increase in self-adherence and mechanical integrity for further processing if permeability is not compromised.

The airlaid composite remain in its lofty array until the composite has been subjected to a heating and cooling step (e.g., calendaring) so that proper and thorough bonding between desiccant and many of the fibers and bicomponent fibers and/or between bicomponent fibers may occur while still in that lofty array. The airlaid composite does not, therefore, have high mechanical integrity at this point of the process. Wet laying processes would not work in the claimed materials due to the unwanted effect of contacting desiccant with water and because it would not be possible to achieve the lofty array required for bonding if the composite were wet-laid prior to the bonding step.

The airlaid composite is then subjected to a bonding step in which the composite passes through a means to activate the bicomponent fibers to bond the airlaid composite (e.g. to melt the sheath of a sheath/core bicomponent fiber). In an embodiment heating allows the bicomponent fibers to form a tacky skeletal structure, which upon cooling, captures and binds many of the desiccant particles and fibers. Heating of the airlaid composite may be achieved for example, by dry heat, as by passing hot air through the composite or by heating it in an electric oven. The heating conditions are controlled at a temperature and air flow rate sufficient to melt only the first polymer component of the bicomponent fiber, while not melting the second polymer component (e.g., melt the sheath and not the core). The secondary fibers should remain unmelted unless used to aid the bicomponent fiber is article formation. As will be understood by one of ordinary skill in the art, proper temperatures and airflow rates are dependent on the type of polymers used in the bicomponent fibers. Of course, the proper heating condition will also be a function of the heating rate of the airflow. As the airflow rate is increased, a lower temperature may be utilized, while decreased flow rate will require an increased temperature to achieve melting within the same time interval. Whatever the conditions used, it is important that the air flow rate not be set at a rate which will result in compression of the airlaid composite as uniform melting will not occur in a compressed composite. The heating may be achieved by other means such as exposing the airlaid composite to radiation, for example, infrared radiation of a suitable intensity and duration, microwave, UV, or ultrasonic welding. It will be understood by one of ordinary skill in the art that subjecting the airlaid composite to such a heating means will remove any surface moisture that may have been present in the particle and fiber components of the composite.

Once the airlaid composite has been heated, it must be cooled prior to calendaring (if needed) to re-solidify the bicomponent fibers, thus binding the bicomponent fibers to the fibers and/or binding the bicomponent fibers together. After forming the airlaid composite, a support structure may be added to the composite whether a support structure has been attached earlier in the process. The support structure may also be attached by unwinding a previously made support structure and attaching to either side of the airlaid composite. The sheet layers will preferably be attached such that the structure will not easily delaminate.

Optionally, a drying step using UV, radiant, convective, plasma or microwave energy. In one embodiment, microwave energy 2.54 GHz, could be included at any step in the process of making or storing the desiccant web. In another embodiment, the microwave drying step is used to dry the desiccant web layer prior to the web being placed into the spacer and sealed in the IGU.

All scientific and technical terms used herein have meanings commonly used in the art unless otherwise specified. The definitions provided herein are to facilitate understanding of certain terms used frequently herein and are not meant to limit the scope of the present disclosure.

The present disclosure is illustrated by the following examples. It is to be understood that the examples, materials, amounts, and procedures are to be interpreted broadly in accordance with the scope and spirit of the disclosure as set forth herein.

### EXAMPLES

The present disclosure will be further explained in greater detail by the examples that follow; however, the scope of this disclosure is not construed to be limited by the scope of these examples.

### Exemplary Section

### Materials:

Bicomponent fiber—bicomponent fiber comprising polyethylene (PE) in the outer sheath and polyethylene terephthalate (PET) in the inner core was obtained from Teknor Apex Co. Fountain City, S.C.). The melting point of the PE sheath is 130° C. and the PET core is 255° C. The denier of the fiber is 6 (2 g/9000 m) and the fiber length is 12.2 mm.
Desiccant—desiccant is a zeolite or silica or a particle mix.
Particle (1)—are Zeolites are microporous adsorbents, a 3 A molecular sieve, obtained from Tricat Zeolite Eurecat U.S. Inc. (Houston, Tex.). The zeolite obtained had a density of 0.55 g/ml and a water absorption at 25° C. and 50% relative humidity of >25.5 wt. %.
Particle (2)—Silica Gel particles are a porous form of silica dioxide. Silica Gel particles of a size 75 to 840 microns were obtained from Multisorb Technologies (Buffalo, N.Y.).
Coated Desiccant Particles—Desiccant particles are coated as described and applied in patents and patent applications U.S. Pat. Nos. 7,491,356, 8,841,358, 8,487,034, 9,249,283, US20100280164, US20160002468, and US20160096934 all commonly assigned to Tundra Composites, LLC. Coated desiccant material is available from Tundra Composites, LLC (White Bear Lake, Minn.).
Polymer and Coated Desiccant Composite—Polymer and coated Desiccant Composite is made using zeolite/silica gel particle ratio is 70/30 by volume percent or 62/26/10 wt. % of zeolite/silica gel/polymer. The composite is available from Tundra Composites and comprises a polyamide adhesive—UNI-REZ®2720 (Arizona Chemicals, (Jacksonville, Fla.). The composite as made was an 80%, by weight, particle mixture and 20%/a, by weight, hot melt polyamide adhesive. Particle size of the desiccant composite ranges from 0.4 mm to 1.5 mm as received from Tundra Composites, LLC and produced from a Wiley Mill, Thomas Scientific (Swedesboro, N.J.).
Canadian Fog Box—Sealed insulated glass units (IGUs) were tested using the Canadian Fog Box ASTM E 2189 (CFB) for analysis of fog formation within the IGU. The IGUs as tested passed the CFB test.
Process for making the web:
Air laid process with polymer desiccant particles.
The particle feeder or volumetric feeder delivered 10 to 82 g/ft² of desiccant composite particles. The particle feeder contained a rotating spindle with holes. White bicomponent fiber of 6 denier and a polyester fiber traveled from a feeder, e.g. a Fiber Controls feeder, to the forming heads via a blower. The line was split to feed both forming heads. The fibers were blown at 10-14 g/ft² into the front and back of a rotating drum that was cleaned of fibers with desiccant on the top side by a roller brush. The fiber falls through the drum holes to the interior of the rotating drum. The fibers were then drawn by vacuum onto the conveyor or a porous film on the conveyor. One particle feeder and one fiber blower was used for each forming head on the air laid line.

For the tests on a 12″ (304.8 mm) system, and other sizes can be used depending on application, there were two forming heads. The first forming head contained desiccant composite particles, bicomponent fiber (PET core, PE outer sheet, optionally colored) and the second forming head contained bicomponent and polyester only. For the 0.6 m wide production line, there were five or six forming heads enabling layers of differing amounts of polyester fluff, bicomponent fiber and desiccant composite particles to be made. The outer layers were fiber only, bicomponent and polyester. The total fiber mix can comprise 20% polyester.

After the forming heads, the air laid product is heated to 164° C. (328° F.) in a 9′ (228.6 mm) in-line furnace at 4.75 ft./min. (120.65 mm/min). The furnace is a drum oven, through air bonding furnace or thermal bonding belt furnace.

Production example of Bicomponent Fiber and desiccant composite particle formed into a layer of the combination of particles and fiber.
Production Parameters are the following:
Web speed 55 inches/minute (1397 mm/min).

### Furnace at 165 C° (329° F.).

Bicomponent fiber from Teknor Apex Co. 20% polyester.
Uni-Rez HM polymer coated particulate with 70 zeolite/30 silica gel vol. % blend. Total air laid desiccant (desiccant composite) weight 82.8 g/ft² (890.3 g/m²), particles 68.1 g/ft² (732.3 g/m²) resulting in 82.2% coated particle content.
Frost Point Measurement Manual Argon lance filled to 99% Argon. Manual IGU build using CRL box spacer. All argon levels remained at >95%.
Per ASTM E576-14 Standard Test Method for Frost/Dew Point of Sealed Insulating Glass Units in the Vertical Position. All passed −70° F. (21° C.) in 2 days for first testing and in 8 days from second air laid trial and testing when the lab had higher humidity (42%) i.e. glass surface had more moisture that remained after argon fill.
Remaining Moisture Adsorption Capacity—Measured moisture uptake rate and maximum weight percent at 75% RH/77° F. (25° C.) on desiccant removed from 14″×20″ (356 mm×508 mm) IGU's after −70° F. (21° C.) frost point. See Table 1 Results. 13 weight % desiccant capacity remained even after ambient moisture exposure due to manual IGU build, fill and desiccant removal.
There were no drying steps in the desiccant testing.

TABLE 1
Moisture Adsorption after IGU Draw Down in CFB test

| | | | % Weight |
|---|---|---|---|
| Particles | Time (hrs) | Weight(g) | Increase |
| Fine (comparative) | 0 | 19.3 | |
| Fine | 1 | 20.5 | 7% |
| Fine | 2 | 20.5 | 7% |
| Fine | 23 | 20.6 | 7% |
| Medium (comparative) | 0 | 20.6 | |
| Medium | 1 | 22.7 | 10% |
| Medium | 2 | 22.7 | 10% |
| Medium | 23 | 22.9 | 11% |
| Coarse (comparative) | 0 | 13.9 | |
| Coarse | 1 | 14.8 | 7% |
| Coarse | 2 | 14.8 | 7% |
| Coarse | 3 | 14.8 | 7% |

Desiccant particles are a 70/30 Vol. % of zeolite to silica gel particles in an air laid bi-component fiber mesh.
Fine particles=<0.400 mm
Medium particles=0.425 mm to 1.20 mm
Coarse particles=>1.450 mm
% increase in weight is calculated ((control—(particle@time))/control).

### Table 2 Adsorption of Samples Before Use in IGU Prior to Testing Via CFB

TABLE 2
Adsorption of Samples before use in IGU
prior to testing via CFB

| | | | % |
|---|---|---|---|
| | Time | | Weight |
| Particles | (hrs) | Weight(g) | Increase |
| Fine (comparative) | 0 | 16.1 | |
| Fine | 1 | 17.6 | 9% |
| Fine | 2 | 17.6 | 9% |
| Fine | 3 | 17.6 | 9% |
| Fine | 4 | 17.6 | 9% |
| Fine | 23 | 17.6 | 9% |
| Medium (comparative) | 0 | 17.7 | |
| Medium | 1 | 19.8 | 12% |
| Medium | 2 | 19.9 | 12% |
| Medium | 3 | 19.9 | 12% |
| Medium | 4 | 19.9 | 12% |
| Medium | 23 | 19.9 | 13% |
| Coarse (comparative) | 0 | 14.9 | |
| Coarse | 1 | 16.4 | 10% |
| Coarse | 2 | 16.4 | 10% |
| Coarse | 3 | 16.4 | 10% |
| Coarse | 4 | 16.4 | 10% |
| Coarse | 23 | 16.4 | 10% |

Desiccant particles are a 70/30 Vol. % of zeolite to silica gel particles in an air laid bi-component fiber mesh.
Fine particles=<0.400 mm
Medium particles=0.425 mm to 1.20 mm
Coarse particles=>1.450 mm
% increase in weight is calculated ((control—(particle@time))/control).
Fine particles (<0.4 mm) and coarse particles (>1.45 mm) have adequate but lower moisture adsorption capacity (see Tables 1 and 2). The fine particles also do not achieve −57° C. (−70° F.) frost point as quickly.

The complete disclosure of all patents, patent applications, and publications cited herein are incorporated by reference. If any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed considering the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

The invention claimed is:

1-32. (canceled)

33. A web comprising a fiber layer that comprises biocomponent fiber, and a particulate comprising a polymer and a desiccant particulate; wherein substantially each particle is bonded to a bicomponent fiber of the fiber layer.

34. The web of claim 33 wherein each particle is partially coated with the polymer.

35. The web of claim 33 comprising a desiccant particulate having a thermoplastic coating of about 1 to 70% of a particle surface area.

36. The web of claim 33 comprising a desiccant particulate having a thermoplastic coating of about 1 to 50% of a particle surface area.

37. The web of claim 33 comprising a zeolite desiccant particulate, a silicon dioxide desiccant particulate or a mixture thereof.

38. The web of claim 33 comprising a desiccant particulate comprising 50 to 99 parts by weight of zeolite and 50 to 1 parts by weight of silicon dioxide.

39. The web of claim 33 wherein the web additionally comprises a secondary fiber.

40. The web of claim 39 wherein the secondary fiber comprises a polyester fiber.

41. The web of claim 33 wherein the bicomponent fiber has a fiber diameter of about 5 to 60μ.

42. The web of claim 33 comprising about 90 to 50 vol. % of desiccant particulate or polymer coated desiccant particulate, and about 10 to 50 wt. % of bicomponent fiber.

43. The web of claim 33 wherein a desiccant particulate or polymer coated desiccant particulate comprises a particle size of about 0.1 to 2 mm.

44. The web of claim 33 wherein a desiccant particulate or polymer coated desiccant particulate comprises a particle size of about 0.4 to 1.5 mm.

45. The web of claim 33 comprising a desiccant particulate having a coating comprising a combination of about 1 to 5 wt. % of an interfacial modifier and a thermoplastic resin, the percentage based on the coating.

46. The web of claim 33 comprising a web thickness of about 1 to 10 mm.

47. The web of claim 33 comprising a web thickness of about 2 to 6 mm.

48. The web of claim 47 further comprising a secondary fiber wherein the secondary fiber forms a discrete layer.

49. The web of claim 48 wherein the secondary fiber comprises a cotton, polyester or polyolefin fluff.

50. The web of claim 33 wherein the web has a desiccant moisture adsorptive capacity of at least 10 wt. % based on desiccant.

51. The web of claim 33 also comprising a removable moisture impermeable protective covering.

52. An insulated glass unit comprising at least two substantially parallel sheets of glass separated by a spacer, the spacer bonded to the glass by at least one sealant, the spacer defining an enclosed interior of the insulated glass unit, the spacer comprising an enclosure having an internal volume, the internal volume at least partially occupied by the web of claim 33.

53. A method of making a desiccant web comprising;
(1) compounding a polymer and a desiccant particulate composition,
(2) airlaying a bicomponent fiber and the polymer and particulate composition; and
(3) fusing the polymer and particulate composition and the bicomponent fiber, thereby forming the desiccant web.
